(19) United States
(12) Patent Application Publication
(10) Pub. No.: US 2006/0092416 A1
(43) Pub. Date: May 4, 2006

(54) In-situ micro-spectro-sensor for detecting gas leakage from vacuum chamber during plasma-based process

(76) Inventors: Jiann-Shiun Kao, Hsinchu (TW); Yi-Chiuen Hu, Hsinchu (TW); Tong-Long Fu, Hsinchu (TW); Han-Chang Pan, Hsinchu (TW); Hui-Hsiung Lin, Hsinchu (TW); Ping-Chung Chung, Hsinchu (TW)

Correspondence Address: RABIN & Berdo, PC, 1101 14TH STREET, NW, SUITE 500, WASHINGTON, DC, 20005, US

(21) Appl. No.: 11/146,086

(22) Filed: Jun. 7, 2005

(30) Foreign Application Priority Data
Oct. 29, 2004 (TW) 093217266

(51) Int. Cl. G01J 3/28

(52) U.S. Cl. 356/326

(57) ABSTRACT

The in-situ micro-spectro-sensor determines whether a leakage occurs during the plasma process by taking the advantage of detecting the target leak in gas specifically composed of 99% of nitrogen and oxygen which are four to one in ratio. Warning signals with light and sound are available. The main part is compact, small and set up is quite convenient. Non-invasive in-situ detection has no effect on in-line process, but can indeed breakthrough the in-situ leak detection barrier for plasma-based process facilities of high-tech industries such as semiconductors and opto-electronics.

### BACKGROUND OF THE INVENTION

1. Field of the Invention

The present invention relates to an in-situ micro-spectro-sensor for detecting gas leakage from vacuum chamber during plasma-based process, and more particularly, to an in-situ micro-spectro-sensor which determines whether a leakage occurs during the plasma by taking the advantage of detecting the target leak-in gas specifically composed of nitrogen and oxygen.

2. Description of the Prior Art

In the wafer fabrication process in a current semiconductor industry, it takes 6 hours to yield a semi-finished product. For example, assuming 40 pieces of 83 wafer per hour are treated in PECVD, the loss of gas leakage in the vacuum chamber during the process is estimated to be; 40(pieces/hour)×30,000(NT$/piece)×6(average hour)=NT$7,200,000.

Of the entire process involved in a semiconductor workshop, 25% thereof belongs to plasma process in which the residual gas analyzers used presently by the method of mass spectrometry for in-situ detection of residual gas compositions from vacuum chambers are not suitable due to high working pressure and negative effect on plasma uniformity.

And helium leak detectors can only operate during shutdowns. Although optical spectrum analyzer are capable of measuring characteristic spectra of gas specimens in plasma, indication of leakage is not available. The detection methods available presently and their disadvantages are enumerated as follows:

| detection method | instrument | disadvantage |
|---|---|---|
| in-situ detection | vacuum gauge | not available for indication of |
| | | leakage |
| in-situ detection | residual gas | mass spectrometry is not suitable |
| | analyzer | due to high working pressure and |
| | | negative effect on plasma |
| | | uniformity |
| Process off for | helium leak | not available for in-situ |
| detection | detector | detection |

Accordingly, the solution to improve the above-mentioned disadvantages is to use in-situ micro-spectro-sensing method. The in-situ micro-spectro-sensor determines whether a leakage occurs during the plasma-based process by taking the advantage of detecting the target leak-in gas specifically composed of 99% of nitrogen and oxygen which are four to one in ratio. Warning signals with both light and sound are available. The main part is compact small and set up is quite convenient. Non-invasive in-situ detection has no effect on in-line process, but can indeed breakthrough the in-situ leak detection barrier for plasma-based process facilities of high-tech industries such as semiconductors and opto-electronics.

### SUMMARY OF THE INVENTION

In-situ micro-spectro-sensor for detecting gas leakage from vacuum chamber during plasma-based process according to the present invention utilizes micro-spectro-sensor for detection of gas (especially nitrogen and oxygen) leakage from the vacuum chamber during plasma-based process. By reason that commonly used residual gas analyzer for detection of variation of gas compositions in the vacuum chamber can only work under vacuum pressure as low as 10˜1 Pa which is not suitable for high working pressure of plasma-based process. Moreover, the mass-spectrometer in the residual gas analyzer has a negative effect on plasma uniformity by its inherent electromagnetic field. The helium leak detector can only operate during the process off. The operating pressure range of helium leak detector is too low to sustain the plasma. Therefore the helium leak detector can not operate as in-situ detection for gas leakage in the vacuum chamber either. The in-situ micro-spectro-sensor of the present invention is a genuine apparatus consisting micro spectrometer and micro-opto-mechatronic system technology that can detect plasma spectrum with optical fibers. The main part is compact, small and set up is quite convenient. The apparatus can be independently operated in a non-invansive way.

### BRIEF DESCRIPTION OF THE DRAWINGS

The drawings disclose an illustrative embodiment of the present invention which serves to exemplify the various advantages and objects hereof, and are as follows:

FIG. 1 is an operational flow chart of the present invention; and

FIG. 2 is plasma spectrogram of the present invention.

### DETAILED DESCRIPTION OF THE PREFERRED EMBODIMENT

The in-situ micro-spectro-sensor of the present invention determines whether a leakage occurs during the plasma-based process by taking the advantage of detecting the target leak-in gas specifically composed of 99% nitrogen and oxygen which are four to one in ratio by comparison between characteristic spectra of gas specimens in plasma and the background spectrum. The accompanied component instruments involved in the in-situ micro-spectro-sensor for detecting gas leakage from vacuum chamber during plasma-based process are a micro-spectro-sensor, a spectrometer, a signal processing unit, and a control unit, the micro-spectro-sensor is minimized in size by means of micro-opto-mechatronic system technology The tangible advantages are:

1. Available for in-situ monitoring of plasma-based process.

2. The main part is compact, small, and set up is convenient.

3. No disadvantageous effect on in-line process.

4. Non-invasive in-situ detection is quite acceptable to semiconductor industry.

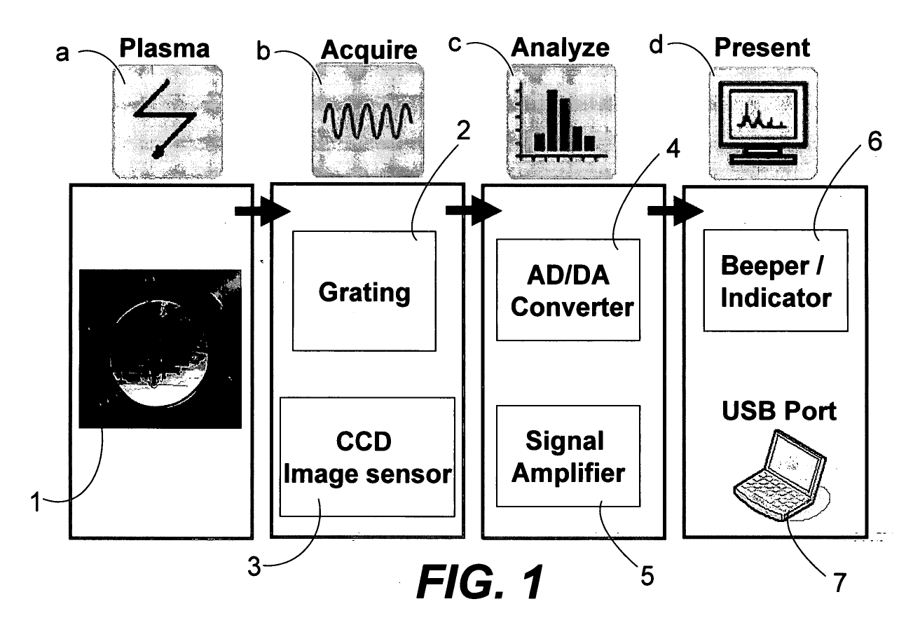

Please refer to FIG. 1. The flow of the detection process according to the present invention comprising following steps:

a. Receiving the light beam coming through a view port 1 on the vacuum chamber during plasma-based process with optical fibers;

b. Picking up optical signals through a concave grating 2 of a spectrometer and a charge coupled device (CCD) or complementary metal oxide semiconductor (CMOS) image sensor 3.

c. Transforming the picked up optical signals into electronic signals and identifying and determining the intensity of oxygen and hydrogen characteristic spectral lines by a signal processing unit composed of a digital/analog converter 4 and a signal amplifier 5; and

d. Transmitting the detected result to a buzzer and a warning: lamp 6 for delivering warning signals with both light and sound, for the convenience of spectrum signal processing, the resultant data are displayed on a terminal computer via a universal serial bus (USB) control interface 7.

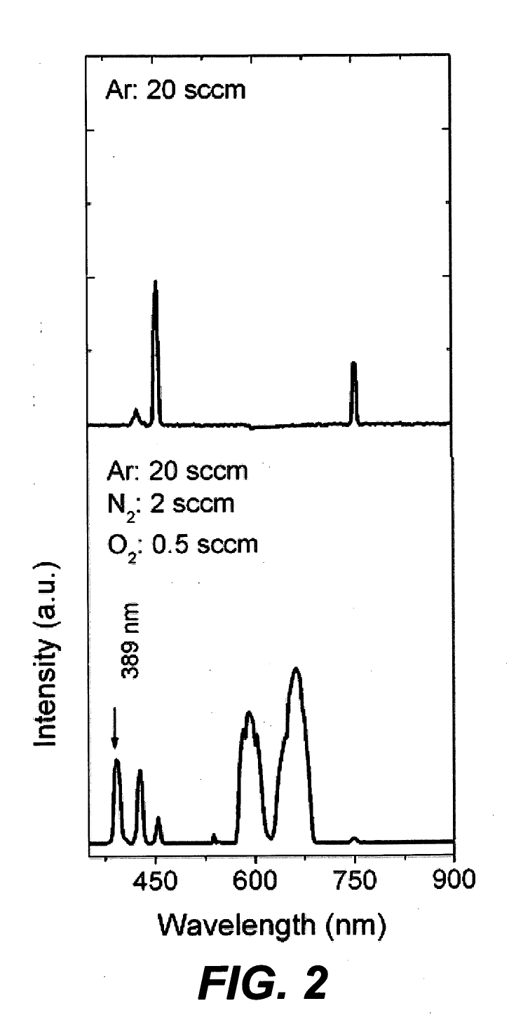

Referring to FIG. 2, the part(A) is a referential background value in which the spectrum of the plasma during sputtering process is mixed with argon plasma, and the part(B) is a resultant spectrum of the plasma in which 2 sccm of nitrogen gas and 0.5 sccm of oxygen gas are conducted into the vacuum chamber simulating as an air leakage, whether a leakage occurs during the plasma-based process is determined by comparing values of part(A) and part(B).

As the spectrometer used presently is too bulky which can only measure the plasma spectra but can not determine whether a leakage occurs. The scope of the present invention is that the plasma spectra are measured by non-invasive in-situ detection available for all industries using plasma-based process to determine whether a leakage occurs in vacuum chambers.

In summary, the in-situ micro-spectro-sensor for detecting gas leakage from vacuum chamber during plasma-based process has several merits such as low cost, compact and small, easy for set up, capable of non-invasive in-situ detection which has no disadvantageous effect on in-line process, but can indeed breakthrough the in-situ barrier for plasma-based process facilities of high-tech industries such as semiconductors and opto-electronics.

While the invention has been described in terms of what are presently considered to be the most practical and preferred embodiment, it is to be understood that the invention need not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. an in-situ micro-spectro-sensor for detecting gas leakage from vacuum chamber during plasma-based process comprising:
an in-situ micro-spectro-sensor detecting the gas leakage from vacuum chambers from characteristical spectra of nitrogen and oxygen during plasma-based process;
a spectrometer for picking up spectrum signals;
a signal processing unit for analyzing and comparing said spectrum signals picked up by said spectrometer; and
a control unit for controlling behavior of aforesaid component instruments.

2. The in-situ micro-spectro-sensor of claim 1, wherein the light emission comes from the vacuum chamber during plasma-based process is received with optical fibers.

3. The in-situ micro-spectro-sensor of claim 1, wherein said spectrometer has a concaved light grid and a charge coupled device (CCD) or complementary metal oxide semiconductor (CMOS) image sensor.

4. The in-situ micro-spectro-sensor of claim 1, wherein said signal processing unit has a digital /analog converter and a signal amplifier for identifying and detecting the the intensity of oxygen and hydrogen characteristic spectral lines.

5. The in-situ micro-spectro-sensor of claim 1, wherein the resultant data detected by said sensor is transmitted to a buzzer and a warning lamp for sending warning signals with both light and sound, or displayed on a terminal computer via a universal serial bus (USB) control interface.
